(19) United States
(12) Patent Application Publication
(10) Pub. No.: US 2020/0148256 A1
(43) Pub. Date: May 14, 2020

(54) TRAILER BACKUP ASSIST SYSTEM USING STEER-BY-WIRE INPUT WITH FEEDBACK ACTUATOR

(71) Applicant: Ford Global Technologies, LLC, Dearborn, MI (US)

(72) Inventor: Matthew Brimmer, Ann Arbor, MI (US)

(73) Assignee: Ford Global Technologies, LLC, Dearborn, MI (US)

(21) Appl. No.: 16/189,199

(22) Filed: Nov. 13, 2018

(51) Int. Cl. B62D 13/06; B62D 15/02

(52) U.S. Cl. CPC B62D 13/06; B62D 5/005; B62D 15/0295; B62D 15/025

(57) ABSTRACT

A trailer backup assist system for a vehicle towing a trailer includes a sensor sensing a hitch angle between the vehicle and the trailer, a steer-by-wire steering handwheel configured to receive a user input trailer path, a controller controlling the vehicle to reverse the trailer along a controlled path based on the sensed hitch angle and the user input, and a feedback actuator coupled to the steering handwheel to provide feedback torque to the steering handwheel in a trailer backup assist mode to limit rotation of the steering handwheel for the user input.

### FIELD OF THE INVENTION

The present invention generally relates to trailer backup assist, and more particularly relates to a vehicle trailer backup assist system having a steering wheel input for controlling the path of a trailer while reversing the trailer.

### BACKGROUND OF THE INVENTION

Automotive vehicles are commonly equipped with a steering handwheel for allowing an operator of the vehicle to control steering of the steerable vehicle road wheels. Some vehicles are equipped with a trailer backup assist system to assist the driver in steering the vehicle with a trailer attached thereto while traveling in reverse. The trailer backup assist system typically includes a separate human machine interface (HMI) such as an interface control knob that is manipulated by the driver operator to control the direction of the trailer as the vehicle steers the trailer in the reverse direction while the driver operator typically applies the acceleration and braking. As a result, the trailer backup assist system generally requires separate steering and trailer backup assist input modules which results in added costs and space consumption. It is desirable to provide for a trailer backup assist system that enhances the driver input functions.

### SUMMARY OF THE INVENTION

According to one aspect of the present invention, a trailer backup assist system for a vehicle towing a trailer is provided. The trailer backup assist system includes a sensor sensing a hitch angle, a steer-by-wire steering handwheel configured to receive a user input of a trailer path, a controller controlling the vehicle to reverse the trailer on the trailer path based on the sensed hitch angle, and a feedback actuator to provide feedback torque to the steering handwheel to limit rotation in a trailer backup mode.

Embodiments of the first aspect of the invention can include any one or a combination of the following features:
the feedback actuator comprises a motor for applying a torque to limit angular rotation of the steering handwheel when in the trailer backup assist mode;
the sensor comprises an imaging device to capture images of the trailer and an image processor to determine the hitch angle based on the captured images;
the steering handwheel is operable in a steering mode to steer the vehicle in the forward direction and is operated in the trailer backup mode to control a path of travel of the trailer in a reverse direction;
the steering handwheel has rotary limits that are reduced when in the trailer backup mode;
the steer-by-wire steering handwheel further comprises a steering angle sensor for sensing the angle of the steering wheel and a road wheel actuator for activating one or more road wheel assemblies on the vehicle;
the steer-by-wire steering handwheel is decoupled from the road wheel actuator when in the trailer backup mode;
the trailer path is a curvature path;
the steering handwheel is part of a power steering assist system; and
the hitch angle is the actuation angle between the vehicle and the trailer.

According to another aspect of the present invention, a trailer backup assist system for a vehicle towing a trailer is provided. The trailer backup assist system includes a sensor sensing a hitch angle between the vehicle and the trailer, a steer-by-wire steering handwheel configured to receive a user input trailer path, a controller controlling the vehicle to reverse the trailer along the trailer path based on the sensed hitch angle, and a feedback actuator coupled to the steering handwheel to provide feedback torque to the steering handwheel to limit rotation of the steering handwheel in a trailer backup mode.

Embodiments of the second aspect of the invention can include any one or a combination of the following features:
The feedback actuator comprises a motor for applying a torque to limit angular rotation of the steering handwheel when in the trailer backup mode;
the sensor comprises an imaging device to capture images of the trailer and an image processor to determine the hitch angle based on the captured images;
the steering handwheel is operable in a steering mode to steer the vehicle in the forward direction and is operated in the trailer backup mode to control the trailer path of the trailer in a reverse direction;
the steering handwheel has rotary limits are reduced in the trailer backup mode;
the steer-by-wire steering handwheel further comprises a steering angle sensor for sensing the angle of the steering wheel and a road wheel actuator for activating one or more road wheel assemblies on the vehicle;
the trailer path of the trailer is a curvature path;
the steering handwheel comprises a power steering assist system; and
the steer-by-wire steering handwheel is decoupled from the road wheel actuator in the trailer backup mode.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a top perspective view of a vehicle attached to a trailer and employing a trailer backup assist system;

FIG. 2 is a top view of the vehicle and trailer showing the trailer articulated relative to the vehicle at different hitch angles;

FIG. 3 is a schematic diagram of a steer-by-wire steering system with feedback actuator for inputting a user input trailer path to the trailer backup assist system, according to one embodiment;

FIG. 4 is a block diagram illustrating the trailer backup assist system with the steering handwheel and feedback actuator;

FIG. 5 is a flow diagram illustrating a routine for implementing the trailer backup assist system with the steering handwheel input;

FIG. 6 is a flow diagram illustrating a routine for setting the actuator feedback in the trailer reverse mode;

FIG. 7 is a graph illustrating the resistance torque provided by the feedback actuator during rotation of the steering handwheel in the trailer backup mode, according to one example; and

FIG. 8 is a graph illustrating the resistance torque provided by the feedback actuator during an anticipated jackknife condition, according to one example.

### DETAILED DESCRIPTION OF THE PREFERRED EMBODIMENTS

For purposes of description herein, it is to be understood that the disclosed trailer backup assist system and the related methods may assume various alternative embodiments and orientations, except where expressly specified to the contrary. It is also to be understood that the specific devices and processes illustrated in the attached drawings, and described in the following specification are simply exemplary embodiments of the inventive concepts defined in the appended claims. While various aspects of the trailer backup assist system and the related methods are described with reference to a particular illustrative embodiment, the disclosed invention is not limited to such embodiments, and additional modifications, applications, and embodiments may be implemented without departing from the disclosed invention. Hence, specific dimensions and other physical characteristics relating to the embodiments disclosed herein are not to be considered as limiting, unless the claims expressly state otherwise.

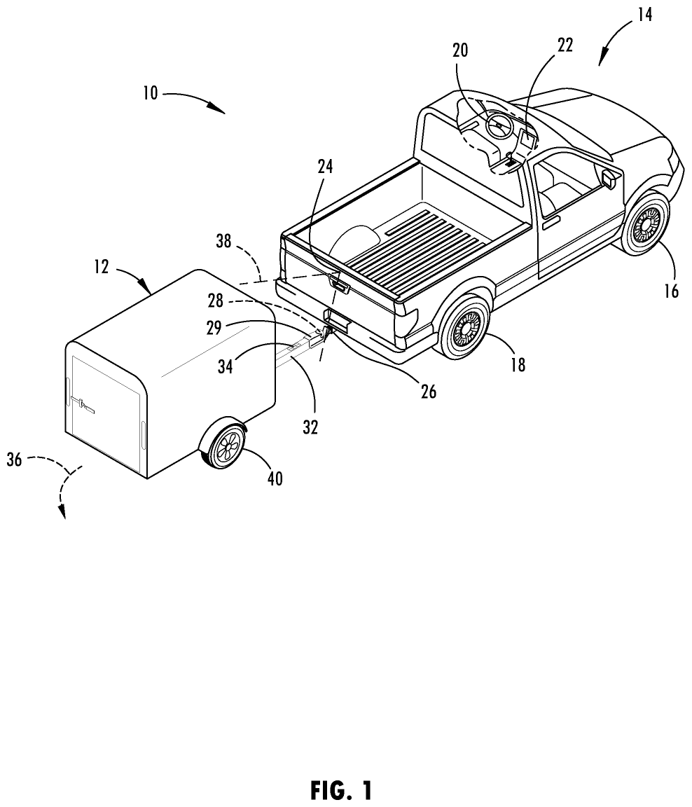

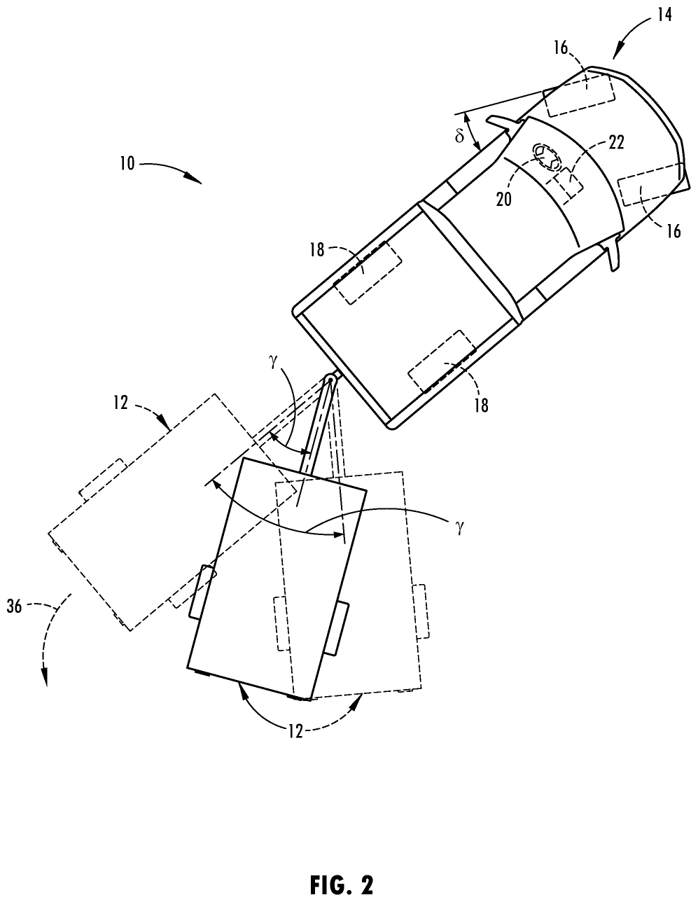

Referring to FIGS. 1 and 2, reference numeral 10 generally designates a trailer backup assist system for controlling the reverse travel backing path of a trailer 12 attached to a vehicle 14. The vehicle 14 is equipped with a steer-by-wire steering system having a steering handwheel 20 that is operable to enable the driver to steer the vehicle during normal manual steered travel without the trailer reverse mode and to input a trailer backing path during reverse travel in the trailer backup mode. The desired backing path 36 may be a desired curvature path of the trailer to follow when backing up, according to one embodiment. In one embodiment, the trailer backup assist system 10 automatically steers the vehicle 14 responsive to the user input backing path in reverse travel to guide the trailer 12 backwards on the desired backing path 36 as a driver uses the accelerator and brake pedals to control the reversing speed of the vehicle 14. While the desired backing path 36 may be a desired curvature path, according to one embodiment, it should be appreciated that other desired trailer backing paths may be input with the steering handwheel 20.

To monitor the position of the trailer 12 relative to the vehicle 14, the trailer backup assist system 10 may include a sensor that senses or otherwise determines the hitch angle γ between the trailer 12 and the vehicle 14. The hitch angle γ is the articulation angle between the longitudinal axis of trailer 12 extending along the length of the trailer tongue 32 and the longitudinal axis of the vehicle 14. In one embodiment, the sensor may include a hitch angle sensor, such as a vision-based system that employs a camera 24 on the vehicle 14 to monitor a target 34 or other identifiable feature or features on the trailer 12 to determine the hitch angle γ. The images captured by the camera 24 are processed by an image processor to identify the location of the target 34 and determine the hitch angle γ.

With reference to the embodiment shown in FIGS. 1 and 2, the vehicle 14 is a pickup truck that is equipped with one embodiment of the trailer backup assist system 10 for controlling the backing path of the trailer 12 that is attached to the vehicle 14 while traveling in the reverse direction, i.e., backing up. Specifically, the vehicle 14 is pivotally attached to one embodiment of the trailer 12 that has a box frame with an enclosed cargo area, a single axle having right and left wheel assemblies 40, and the trailer tongue 32 longitudinally extending forward from the enclosed cargo area. The illustrated trailer 12 also has a trailer hitch connector in the form of a coupler assembly 29 that is connected to a vehicle hitch connector 26 in the form of a hitch ball 28. The coupler assembly 29 latches onto the hitch ball 28 to provide a pivoting ball joint connection that allows for articulation of the hitch angle γ. It should be appreciated that additional embodiments of the trailer 12 may alternatively couple with the vehicle 14 to provide a pivoting connection, such as by connecting with a fifth wheel connector. It is also contemplated that additional embodiments of the trailer 12 may include more than one axle and may have various shapes and sizes configured for different loads and items, such as a boat trailer or a flatbed trailer.

Referring to FIG. 1, the sensor in the illustrated embodiment includes a vision-based hitch angle sensor for sensing the hitch angle γ between the vehicle 14 and the trailer 12. The illustrated hitch angle sensor employs a camera 24 (e.g. video imaging camera) that may be located proximate an upper region of the vehicle tailgate at the rear of the vehicle 14, as shown, such that the camera 24 may be elevated relative to the tongue 32 of the trailer 12. The illustrated camera 24 has an imaging field of view 38 located and oriented to capture one or more images of the trailer 12, including a region containing one or more desired target placement zones for at least one target 34 to be secured, according to one embodiment. Although it is contemplated that the camera 24 may capture images of the trailer 12 without a target 34 to determine the hitch angle γ, in the illustrated embodiment, the trailer backup assist system 10 includes a target 34 placed on the trailer 12 to allow the trailer backup assist system 10 to utilize information acquired via image acquisition and processing of the target 34. For instance, the illustrated camera 24 may include a video imaging camera that repeatedly captures successive images of the trailer 12 that may be processed to identify the target 34 and its location on the trailer 12 for determining movement of the target 34 and the trailer 12 relative to the vehicle 14 and the corresponding hitch angle γ. It should also be appreciated that the camera 24 may include one or more video imaging cameras and may be located at other locations on the vehicle 14 to acquire images of the trailer 12 and the desired target placement zone, such as on a passenger cab of the vehicle 14 to capture images of a gooseneck trailer. Furthermore, it is contemplated that additional embodiments of the hitch angle sensor for providing the hitch angle γ may include one or a combination of a potentiometer, a magnetic-based sensor, an optical sensor, a proximity sensor, a rotational sensor, a capacitive sensor, an inductive sensor, or a mechanical based sensor, such as a mechanical sensor assembly mounted to the pivoting ball joint connection, energy transducers of a reverse aid system, a blind spot system, and/or a cross traffic alert system, and other conceivable sensors or indicators of the hitch angle γ to supplement or be used in place of the camera 24.

The vehicle 14 is shown equipped with a touchscreen display 22 located in the dashboard forward of the center console and the driver's seat and viewable by the driver. The touchscreen display 22 may display the images captured by the camera 24 rearward of the vehicle when the vehicle is in reverse and may provide instructions and warnings to the driver related to the trailer backup assist system. The touchscreen display 22 may also receive operator inputs for the trailer backup assist system 10.

As shown in FIG. 2, the trailer 12 is oriented at a hitch angle γ relative to a longitudinal axis of the vehicle 14 which varies as the trailer 12 articulates about the coupler assembly 32 pivoting about the hitch ball 28 as the vehicle 14 and trailer 12 are backed up. The vehicle 14 has a steering handwheel 20 located in front of the driver's seat that is operated by a driver of the vehicle 14 to steer the steerable road wheel assemblies 16 to steer the vehicle 14 on a driver steered path. The steering handwheel 20 is used to steer the steerable road wheel assemblies 16 when the vehicle 14 and trailer 12 are not in a trailer backup assist mode such as when the vehicle 14 is traveling forward with the trailer 12 or is traveling forward or rearward without a trailer. When the vehicle 14 and trailer 12 are in the trailer backup assist mode and the vehicle 14 and trailer 12 are coupled and backing up, the steering handwheel 20 is used as an input by the driver to input the desired backing path of the trailer 12 in a trailer backup mode.

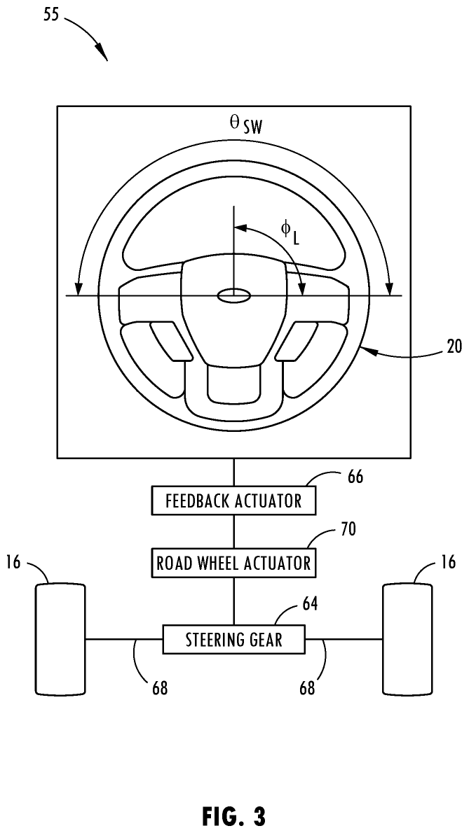

The steering handwheel 20 is part of a steer-by-wire steering system 55 as shown in FIG. 3 which employs a road wheel actuator 70 as part of a power assist steering system of the vehicle 14 to operate the steerable road wheel assemblies 16 of the vehicle 14. In one embodiment, the power assist steering system may be an electric power-assisted steering (EPAS) system that includes an electric steering motor for turning the steerable handwheel assemblies 16 with road wheels via a steering gear 64 and tie-rods 68. The steer-by-wire steering system 55 may decouple the road wheel actuator 70 from the steering handwheel 20 when in the trailer backup mode to allow the driver to input the desired trailer backing path such that the steering system provides autonomous steering of the vehicle 14 and trailer 12 during the trailer backup maneuver. The steer-by-wire steering system 55 further includes a feedback actuator 66 for providing feedback torque to the steering handwheel 20 to limit the rotation of the steering wheel angle θ_{SW} of the steering handwheel 20 by a limited end stop angle ϕ_{L}.

In the normal driving mode when the vehicle and trailer are not in the trailer backup mode, the steering handwheel 20 may be rotated by a steering handwheel angle θ_{SW} which may be about ±500°, according to one embodiment. In the trailer backup mode, the steering angle θ_{SW} is limited to the limited end stop angle ϕ_{L} which may be in the range of ±70° to ±90°. As such, the limited end stop angle ϕ_{L} limits the rotation of the steering handwheel 20 for inputting a desired trailer path for backing the trailer 12. The feedback actuator 66 provides a torque resistance to the steering handwheel 20 to apply rotational end stops in both directions of rotation to limit the steering handwheel angle θ_{SW} to the limited end stop angle ϕ_{L}.

The feedback actuator 66 may include a torque resistance electric motor that provides a torque to the steering handwheel 20 to prevent or limit rotation of the steering handwheel angle θ_{SW} beyond the limited end stop angle ϕ_{L} while operating in the trailer backup mode. The feedback actuator 66 may apply a low torque feedback less than 5 newton meters, such as 3 newton meters, when the steering angle θ_{SW} is less than the limited end stop angle ϕ_{L} and a further reduced torque at the centered position of the steering handwheel. According to one embodiment, the feedback actuator 66 may provide an increased torque of at least 8 newton meters to resist further rotation of steering handwheel 20 at the limited end stop angle ϕ_{L}. According to another embodiment, the feedback actuator 66 may provide a greater torque of at least 200 newton meters at or beyond the limited end stop angle ϕ_{L}. As a result, the feedback actuator 66 provides an end stop resistance at both limited ends of rotation of the steering handwheel 20 which may be a fixed torque, according to one embodiment or may ramp up and increase as the steering wheel approaches and tries to go beyond the limited angle ϕ_{L}. In the event that the vehicle 14 and trailer 12 are anticipated to experience a jackknife condition, the feedback actuator 66 may provide a torque to further limit rotation of the steering handwheel 20 so as to prevent the jackknife condition from occurring.

The steer-by-wire steering system 55 allows the steering handwheel 20 to be partially or fully mechanically decoupled from movement of the steerable road wheel assemblies 16 of the vehicle 14. As such, the steering handwheel 20 can be rotated independent of the manner in which the power steering system in a vehicle controls the steerable road wheel assemblies 16. As such, the steering handwheel 20 can be used to steer the steerable road wheel assemblies 16 of the vehicle 14 and can be decoupled and switched to a trailer backup assist mode to allow use of the steering handwheel 20 as an input to input a desired backing path 36 of the trailer 12, thereby eliminating the need for a separate user input to input the backing path 36 of the trailer 12 in the trailer backup mode.

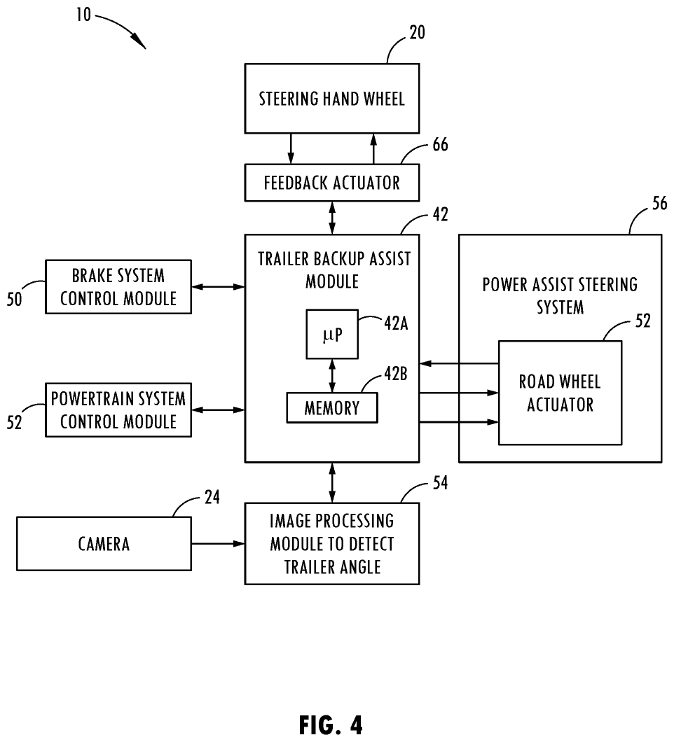

Referring to FIG. 4, the trailer backup assist system 10 is illustrated in further detail. The trailer backup assist system 10 includes a trailer backup assist module 42 which may include a microprocessor 42A and memory 42B, according to one embodiment. The trailer backup assist module 42 may include other analog and/or digital circuitry, according to other embodiments. The trailer backup assist module 42 communicates with a brake system control module 50 and a powertrain system control module 52. In addition, a power-assist steering system 56 communicates with the trailer backup assist module 42 and controls signals to the road wheel actuator 70. The power-assist steering system is part of the steer-by-wire steering system that may decouple the steering handwheel 20 from the road wheel actuator 52 in the trailer backup mode.

The camera 24 is shown providing an input to an image processing module 54. The image processing module 54 processes the video images generated by the camera 24 to determine the trailer hitch angle δ. The trailer angle δ is input to the trailer backup assist module 42 and used to control the vehicle to reverse the trailer along a controlled path.

The steering handwheel 20 is shown coupled to the feedback actuator 66 which, in turn, is coupled to the trailer backup assist module 42. A user may utilize the steering handwheel 20 to drive the road wheel actuator to actuate steering of the vehicle road wheel assemblies when the vehicle 14 is not in a trailer backup mode. When the vehicle 14 is in the trailer backup mode, the steering handwheel 20 enables a user to input a desired trailer path 36 while backing the trailer 12. In the trailer backup mode, the power-steering assist system 56 is decoupled from the road wheel actuator to allow the driver to input the trailer backing path with a steering wheel angle θ_{SW} limited by limited end step angle ϕ_{L} as the result of the feedback actuator 66 limiting the rotation of the steering handwheel 20. As such, the steering handwheel 20 has a normal vehicle operating rotational range and a limited trailer backup mode range to serve as a dual purpose input, thereby eliminating the need for a separate trailer backup assist user input.

The vehicle brake control system 50 may also communicate with the trailer backup assist module 42 to provide the trailer backup assist system 10 with braking information, such as vehicle wheel speed, and to receive braking commands from the trailer backup assist module 42. For instance, vehicle speed information can be determined from individual wheel speeds as monitored by the brake control system 50. Vehicle speed may also be determined from the powertrain control system 52 which can also receive acceleration commands from the trailer backup assist module 42. For example, the trailer backup assist system 10 in some embodiments may regulate speed of the vehicle 14 during backing of the trailer 12, which can reduce the potential for unacceptable trailer backup conditions. Examples of unacceptable trailer backup conditions include, but are not limited to, a vehicle 14 over speed condition, a high hitch angle rate, trailer angle dynamic instability, a calculated theoretical trailer jackknife condition (defined by a maximum vehicle steering angle, drawbar length, tow vehicle wheelbase, and an effective trailer length), or physical contact jackknife limitation (defined by an angular displacement limit relative to the vehicle 14 and the trailer 12), and the like. The trailer backup assist system 10 can issue an alert signal corresponding to a notification of an actual, impending, and/or anticipated unacceptable trailer backup condition.

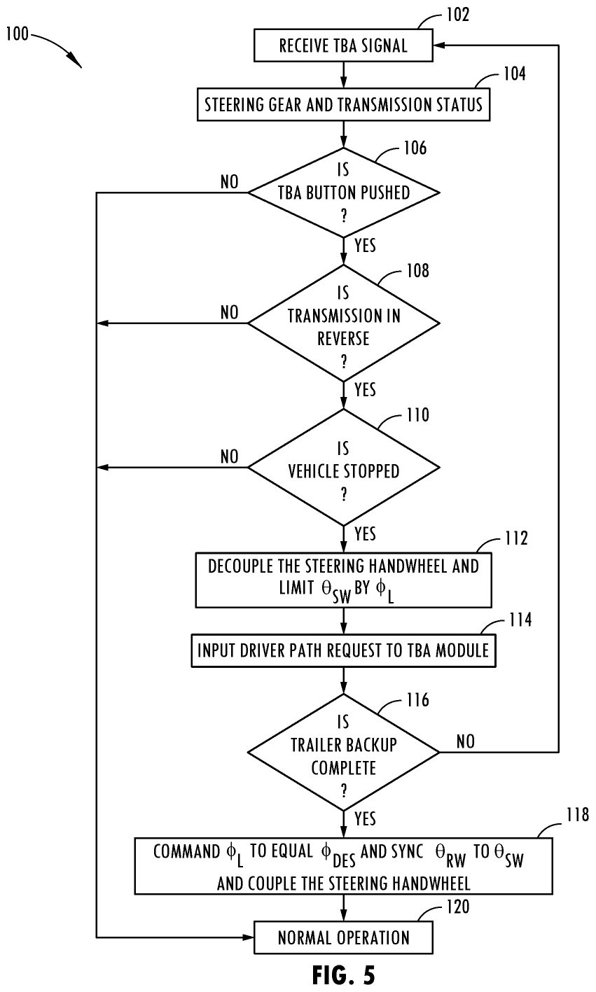

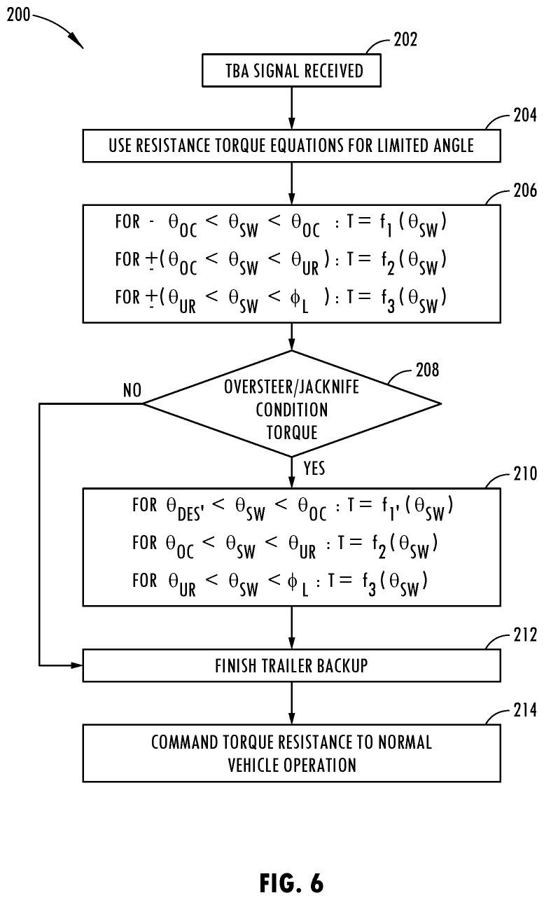

Referring to FIG. 5, a routine 100 for controlling the trailer backup assist system 10 is illustrated, according to one embodiment. The routine 100 may be stored in memory 42B and executed by the microprocessor 42A of the trailer backup assist module 42. The routine 100 begins at step 102 when receiving a trailer backup assist signal to enter the trailer backup assist mode. Next, the steering gear and transmission status is determined at step 104. At decision step 106, routine 100 determines if a trailer backup assist (TBA) input button or other input has been pushed or activated and, if not, continues with normal operation of the vehicle at step 120. The TBA input may be input by the vehicle operator with menu selections on a display, a pushbutton input or other input device. If the TBA input button has been pushed or otherwise activated, routine 100 proceeds to decision step 108 to determine if the vehicle transmission is in reverse gear and, if not, proceeds to step 120 to resume normal operation of the vehicle. If the transmission gear is in reverse gear, routine 100 proceeds to step 110 to determine if the vehicle is stopped and, if not, resumes normal operation of the vehicle without trailer backup assist at step 120. Otherwise, if the vehicle speed is stopped, then routine 100 proceeds to step 112 to decouple the steering handwheel from the road wheel actuator and limit the steering handwheel angle θ_{SW} by a limited end stop angle ϕ_{L} at step 112. This is achieved by employing the feedback actuator to limit the rotation of the steering handwheel, according to a routine shown in FIG. 6.

Next, routine 100 proceeds to step 114 to input the driver reverse trailer path request to the trailer backup assist module. The inputted driver reverse trailer path request is the requested path the trailer is to follow in reverse as input by the operator via the steering handwheel in the trailer backup assist mode. Next routine, routine 100 proceeds to step 116 to determine if the trailer backup is complete and, if not, returns to step 102 to receive the TBA signal. If the trailer backup is complete, routine 100 proceeds to step 118 to command the limited steering angle ϕ_{L} to equal a dynamic end stop angle θ_{DES} and to sync the road wheel angle θ_{RW} to the steering handwheel angle θ_{SW} to thereby couple the steering handwheel to the road wheel actuator, before resuming normal operation at step 120.

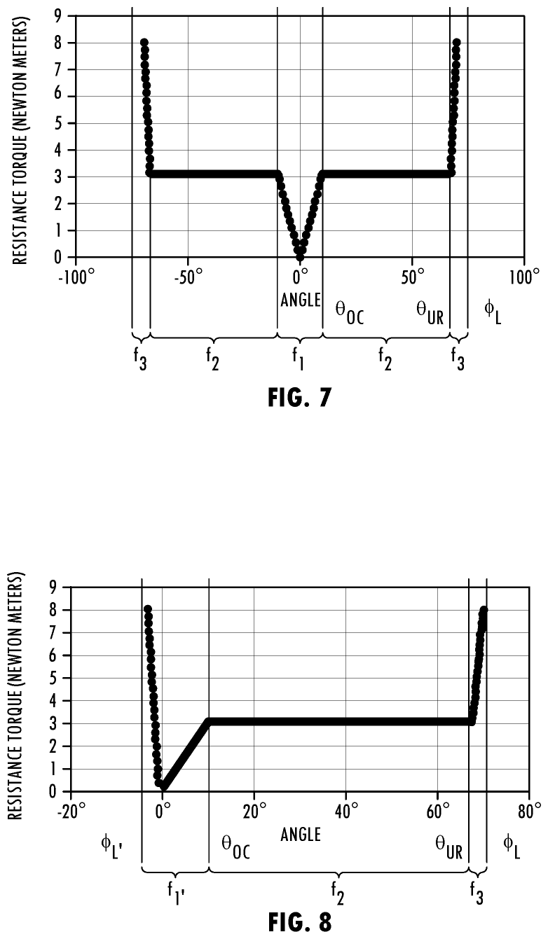

Referring to FIG. 6, a routine 200 for limiting the steering angle by the limited angle with the feedback actuator is shown, according to one embodiment. Routine 200 is shown beginning at step 202 when a trailer backup assist (TBA) signal is received and proceeds to step 204 to use resistance torque equations for the limited angle when in the trailer backup mode. Next, routine 200 proceeds to step 206 to utilize the resistance torque equations based on the steering handwheel angle θ_{SW}. In the example shown in block 206 and as illustrated in FIG. 7, the resistance torque generated by the feedback actuator is determined based upon one of the three torque functions depending upon the steering handwheel angle θ_{SW}. When the steering handwheel angle θ_{SW} is in the range between negative θ_{OC} and positive θ_{OC} which is an on center angle range shown at approximately negative 10° to positive 10°, the torque generated by the torque actuator is determined based on the first function f₁ (θ_{SW}). Function f₁ (θ_{SW}) is shown in FIG. 7 having a ramping function with a resistance torque of zero when the steering handwheel angle θ_{SW} is 0° and ramping up to approximately 3 newton meters when the steering handwheel angle θ_{SW} approaches either negative 10° or positive 10°. When the steering handwheel angle θ_{SW} is between the on center angle range θ_{OC} and a user range angle θ_{UR}, the resistance torque is determined based on a second function f₂ (θ_{SW}) which is shown as a constant value of about 3 newton meters in FIG. 7 extending from approximately positive 10° to 65° and from negative 10° to negative 65°. When the steering handwheel angle _{SW} is in a range greater than the user range angle θ_{UR} up until a dynamic end stop angle ϕ_{L}, the resistance torque is defined by a function f₃ (θ_{SW}) which is shown in FIG. 7 ramping between 3 and 8 newton meters from approximately positive 65° to 70° and from negative 65° to negative 70°. It should be appreciated that the torque resistance generated by the third function is a torque that increases from approximately 3 newton meters to 8 newton meters, according to one example to provide a soft end stop feel as the steering handwheel is rotated to the end limit. It should be appreciated that the functions f₁ (θ_{SW}), f₂ (θ_{SW}), and f₃ (θ_{SW}), also shown in FIG. 7 as f₁, f₂, f₃, respectively, may follow other torque resistance curves, according to other examples.

Referring back to FIG. 6, routine 200 proceeds to step 208 to determine if there is an oversteer or jackknife condition torque that is needed when an anticipated oversteer or jackknife condition is detected. When this occurs, routine 200 may employ other torque resistance functions to limit the rotation of the steering handwheel. As seen in block 210, the functions for defining the steering torque during an oversteer or jackknife condition are shown as functions f₁′ (θ_{SW}), f₂ (θ_{SW}) and f₃ (θ_{SW}) depending on the steering handwheel angle θ_{SW}. When the steering handwheel angle θ_{SW} is within a range defined by a reduced dynamic end stop angle θ_{DES}′ up until the on center angle range, the torque resistance is set at function f₁′ (θ_{SW}) which is seen in FIG. 8 generating a ramping torque for an angle between about −5° to +10°. When the steering handwheel angle θ_{SW} is between the on center angle range and the user range angle θ_{UR}, the torque function follows the second function f₂ (θ_{SW}) which extends in this example from approximately +10° to +65° as seen by f₂ in FIG. 8. When the steering handwheel angle θ_{SW} is greater than the user range angle θ_{UR} up until the dynamic end stop angle ϕ_{L}, the torque resistance is set at the third function f₃ (θ_{SW}) which is shown as f₃ in FIG. 8 for angles of approximately +65° to +70°. Thus, the jackknife condition may trigger one or more different torque resistance functions for limiting rotation of the steering handwheel to prevent a jackknife or oversteer condition from occurring.

Next, routine 200 proceeds to step 212 to finish the trailer backup. Thereafter, routine 200 proceeds to step 214 to command the torque resistance to go back to the normal vehicle operation.

Accordingly, the trailer backup assist system 10 advantageously employs a steer-by-wire steering system with a feedback actuator to both steering the vehicle road wheel assemblies 16 and allow an operator to input a requested trailer path for reverse backing of the trailer. This eliminates the need for a separate trailer path input and allows the trailer path input device to be at a location directly in front of the driver.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A trailer backup assist system for a vehicle towing a trailer, comprising:
a sensor sensing a hitch angle;
a steer-by-wire steering handwheel configured to receive a user input of a trailer path;
a controller controlling the vehicle to reverse the trailer on the trailer path based on the sensed hitch angle; and
a feedback actuator to provide feedback torque to the steering handwheel to limit rotation in a trailer backup mode.

2. The system of claim 1, wherein the feedback actuator comprises a motor for applying a torque to limit angular rotation of the steering handwheel when in the trailer backup assist mode.

3. The system of claim 1, wherein the sensor comprises an imaging device to capture images of the trailer and an image processor to determine the hitch angle based on the captured images.

4. The system of claim 1, wherein the steering handwheel is operable in a steering mode to steer the vehicle in the forward direction and is operated in the trailer backup mode to control a path of travel of the trailer in a reverse direction.

5. The system of claim 4, wherein the steering handwheel has rotary limits that are reduced when in the trailer backup mode.

6. The system of claim 4, wherein the steer-by-wire steering handwheel further comprises a steering angle sensor for sensing the angle of the steering wheel and a road wheel actuator for activating one or more road wheel assemblies on the vehicle.

7. The system of claim 6, wherein the steer-by-wire steering handwheel is decoupled from the road wheel actuator when in the trailer backup mode.

8. The system of claim 1, wherein the trailer path is a curvature path.

9. The system of claim 1, wherein the steering handwheel comprises a power steering assist system.

10. The system of claim 1, wherein the hitch angle is the actuation angle between the vehicle and the trailer.

11. A trailer backup assist system for a vehicle towing a trailer, comprising:
a sensor sensing a hitch angle between the vehicle and the trailer;
a steer-by-wire steering handwheel configured to receive a user input trailer path;
a controller controlling the vehicle to reverse the trailer along the trailer path based on the sensed hitch angle; and
a feedback actuator coupled to the steering handwheel to provide feedback torque to the steering handwheel to limit rotation of the steering handwheel in a trailer backup mode.

12. The system of claim 11, wherein the feedback actuator comprises a motor for applying a torque to limit angular rotation of the steering handwheel when in the trailer backup mode.

13. The system of claim 11, wherein the sensor comprises an imaging device to capture images of the trailer and an image processor to determine the hitch angle based on the captured images.

14. The system of claim 11, wherein the steering handwheel is operable in a steering mode to steer the vehicle in the forward direction and is operated in the trailer backup mode to control the trailer path of the trailer in a reverse direction.

15. The system of claim 14, wherein the steering handwheel has rotary limits are reduced in the trailer backup mode.

16. The system of claim 14, wherein the steer-by-wire steering handwheel further comprises a steering angle sensor for sensing the angle of the steering wheel and a road wheel actuator for activating one or more road wheel assemblies on the vehicle.

17. The system of claim 14, wherein the trailer path of the trailer is a curvature path.

18. The system of claim 11, wherein the steering handwheel is part of a power steering assist system.

19. The system of claim 16, wherein the steer-by-wire steering handwheel is decoupled from the road wheel actuator in the trailer backup mode.
